(19) United States
(12) Patent Application Publication
(10) Pub. No.: US 2001/0047735 A1
(43) Pub. Date: Dec. 6, 2001

(54) Optronic fuse

(75) Inventor: Andreas Ganghofer, Nurnberg (DE)

Correspondence Address: Leopold Presser, Scully, Scott, Murphy & Presser, 400 Garden City Plaza, Garden City, NY, 11530, US

(73) Assignee: Diehl Munitionssysteme GmbH & Co. KG, Rothenbach (DE)

(21) Appl. No.: 09/866,969

(22) Filed: May 29, 2001

(30) Foreign Application Priority Data
Jun. 2, 2000 (DE) 100 27 469.2

(51) Int. Cl. G01C 3/08; F42C 13/02

(52) U.S. Cl. 102/213; 356/5.01

(57) ABSTRACT

An optronic fuse for the warhead of a weapon system equipped with an intelligent sensor arrangement, wherein the fuse operates on the basis of the pulse transit time process and implements echo transit time measurement. In order in the weapon system to be able to steplessly freely program the desired detonation range at short notice and to be able to handle a large signal dynamic range, for the purposes of measuring the echo transit time there is provided a time-digital converter which for example is a fast counter or components which operate with the addition of very small gate passage times.

The invention concerns an optronic fuse as set forth in the classifying portion of claim 1.

DE 24 56 162 C2 discloses a missile fuse with an opto-electronic measuring device which operates in accordance with the basic principle and which, upon reaching a given range between the missile and a target surface, delivers a signal to an evaluation circuit, wherein the measuring device has a transmitter which emits optical pulses at a pulse repetition frequency through a lens and a receiver which is arranged at a given spacing from the transmitter and which records portions of those optical pulses, which are returned from the surface by way of a further lens, with a narrow-band filter which is tuned to the pulse repetition frequency and a receiving amplifier. To eliminate the effects of circuitry-induced frequency deviations, connected between the band pass filter and the transmitter is a regulating circuit by which the pulse repetition frequency of the transmitter tracks the centre frequency of the band pass filter. The input signal of the regulating circuit is a signal which is filtered out of the noise level of the receiving amplifier by the band pass filter.

An optical range sensor for a missile fuse which operates on the basis of the pulse reflection principle and which in the reception branch has in series an amplifier, a gate circuit which is opened in the transmission pulse cycle, an integrating capacitor circuit and a threshold switch, is known from DE 26 08 066 C2. In that case, arranged in the reception branch upstream of the gate circuit is a high pass filter whose limit frequency is slightly below the transmission pulse repetition frequency. The integrating capacitor circuit serves to sum positive and negative signal components in accordance with the sign thereof.

An optronic fuse is also known for example from DE 39 27 819 C2.

For many weapon systems which are predominantly equipped with an intelligent sensor arrangement, it may be desirable to trigger the warhead at an optimum operative range which is dependent on the respective type of target. The optronic fuses which are to be used for that purpose must be capable of offering the weapon system more than a detonation range. It is preferred if the weapon system can at short notice steplessly freely program the detonation range which is respectively required. That means that the fuses may not involve a fixedly set detonation range and must be capable of handling a large signal dynamic range.

Hitherto detonation triggering is effected by a comparison of the echo transit time with a fixedly set reference time, for example by a delay line or by a phase shift.

The object of the present invention is to provide an optronic fuse of the kind set forth in the opening part of this specification, in which the detonation range which is respectively desired can be steplessly freely programmed at short notice, while a very great signal dynamic range can be handled.

In accordance with the invention that object is attained by the features of claim 1. Preferred developments of the optronic fuse according to the invention are characterised in the appendant claims.

In the case of the optronic fuse according to the invention, detonation triggering is effected not by a comparison of the echo transit time with a fixedly predetermined reference time, such as for example by a delay line or by a phase shift, but by true stepless time measurement. In that case, the echo transit time is measured with a time-digital converter. For example fast counters present themselves for that purpose, that is to say as a time-digital converter. Another possible option is that of using components which operate with an addition of very small gate passage times. In accordance with the invention detonation triggering is effected by a comparison of the respectively current counter state and the programmed counter state. In order to be able to process the large signal dynamic which occurs in the case of a variable extent of ranges, it is preferred if a variable gain amplifier (VGA) is incorporated into the signal processing chain, upstream of the time-digital converter. For that purpose, the VGA is capable of compensating for the range dependency of the signal, insofar as a suitable gain factor is derived from the current time measurement. That advantageously provides that signal evaluation only has to be capable of processing the dynamic range of target reflectivity.

The optical fuse for the warhead of a weapon system equipped with an intelligent sensor arrangement therefore operates on the basis of the pulse transit time process and implements echo transit time measurement. In order, in the weapon system, to be able to steplessly freely program the desired detonation range at short notice and in order to be able to handle a large signal dynamic range, provided for measurement of the echo transit time is a time-digital converter, in conjunction with an upstream-disposed VGA, which for example is a fast counter or components which operate with an addition of very small gate passage times.

The advantages achieved with the invention are that the warhead combined with the optronic fuse can be fired in target-adaptive manner, that a stand-off universal fuse can be embodied, which can be adapted by programming to any warhead without a change in electronics, and that a stand-off universal fuse can be embodied, which can be adapted by programming to any position of installation of the weapon system without a change in electronics. In this last-mentioned connection reference is directed for example to DE 38 21 218 A1 which describes an overfly projectile for combating a target object detected from a low search trajectory by means of a warhead on board the overfly projectile.

1. An optronic fuse for the warhead of a weapon system equipped with an intelligent sensor arrangement, wherein the fuse operates on the basis of the pulse transit time process and implements echo transit time measurement, characterised in that there is provided a time-digital converter for measurement of the echo transit time.

2. An optronic fuse according to claim 1 characterised in that the time-digital converter has a fast counter.

3. An optronic fuse according to claim 1 characterised in that the time-digital converter has components for the addition of very small gate passage times.

4. An optronic fuse according to one of claims 1 to 3 characterised in that a variable gain amplifier (VGA) is connected in the signal processing chain for echo transit time measurement upstream of the time-digital converter.

5. An optronic fuse according to claim 1 characterised in that the triggering distance can be freely programmed.

6. An optronic fuse according to claim 1 characterised in that the triggering distance can be freely selected up to shortly before a mission end.
